(19) United States
(12) Patent Application Publication
(10) Pub. No.: US 2026/0218747 A1
(43) Pub. Date: Jul. 30, 2026

(54) BEARING HOLDING DEVICE AND MOTOR

(71) Applicant: MABUCHI MOTOR CO., LTD., Chiba (JP)

(72) Inventor: Ryoichi SUGITA, Chiba (JP)

(21) Appl. No.: 19/147,323

(22) PCT Filed: Oct. 26, 2023
(86) PCT No.: PCT/JP2023/038742

§ 371 Date: Jul. 11, 2025

(51) Int. Cl. F16C 27/06; F16C 25/04; H02K 5/167

(52) U.S. Cl. CPC F16C 27/063; F16C 25/04; H02K 5/1672; F16C 2380/26

(57) ABSTRACT

A bearing holding device for holding a sliding bearing rotatably supporting a shaft includes an opposing surface facing an end surface of the sliding bearing on one side in an axial direction, and a holding portion extending from the outer edge of the opposing surface toward the other side in the axial direction. The holding portion has a claw portion that restricts movement of the sliding bearing to the other side and contacts an other-side outer peripheral surface of the outer peripheral surface of the sliding bearing on the other side and presses the sliding bearing inward in a radial direction to hold the sliding bearing, and a connection portion connecting the opposing surface and the claw portion to each other. A gap is provided between the connection portion and a one-side outer peripheral surface of the outer peripheral surface on the one side.

### TECHNICAL FIELD

The present invention relates to a bearing holding device that holds a sliding bearing rotatably supporting a shaft, and a motor to which the bearing holding device is applied.

### BACKGROUND ART

Conventionally, as a bearing holding device, there has been known one including a substantially disk-shaped bottom portion, a holding portion standing at the periphery of the bottom portion, and an opening formed on the tip end side of the holding portion, and holding a bearing inserted from the opening side of the bearing holding device by the elastic force (restoring force) of the holding portion. For example, Patent Literature 1 discloses a basket-shaped bearing holding device (bearing holder) including a circular ring-shaped bottom portion and a plurality of holding claw portions standing at equal intervals in the circumferential direction of the circular ring on the bottom portion. In the bearing holder of Patent Literature 1, the holding claw portion forms a substantially spherical inner peripheral surface, and a bearing inserted into the bearing holder is held by being closely fitted into the spherical inner peripheral surface. Note that Patent Literature 1 describes, as an example, a spherical sliding bearing as the bearing held by the bearing holder, but a bearing holding device having a similar shape can also be used for a cylindrical sliding bearing.

### CITATION LIST

### Patent Literature

Patent Literature 1: JP-A-2012-244890

### DISCLOSURE OF THE INVENTION

### Problems to be Solved by the Invention

Here, the sliding bearing is a generic term for a bearing that supports a rotating body (for example, shaft) while lubricating the rotating body by the lubricity of the material itself of the bearing or an oil film of lubricant filling the inside of the bearing. The sliding bearing may generate abnormal noise (for example, high-pitched noise) during rotation of the shaft depending on the state of the lubrication. In particular, under low temperature environment, the lubricity of the sliding bearing decreases, and for this reason, the above-described abnormal noise is likely to occur. Thus, for the bearing holding device, not only a function of holding the sliding bearing, but also reduction in the generation of such abnormal noise are demanded.

The bearing holding device and motor of the present invention have been devised in view of such problems, and an object thereof is to reduce generation of abnormal noise around a sliding bearing. Note that objects of the present invention are not limited to this object, but also include another object of exerting operations and effects that can be derived from configurations presented in DESCRIPTION OF PREFERRED EMBODIMENTS described below, the operations and effects being unobtainable by the known technology.

### Solutions to the Problems

The bearing holding device and motor of the disclosure can be achieved as aspects (application examples) disclosed below, and solve at least some of the above-described problems. Any of Aspect 2 and subsequent aspects is an aspect that can be additionally selected as appropriate, and is an aspect that can be omitted. Any of Aspect 2 and the subsequent aspects does not disclose an aspect and configuration that are essential to the present invention.

Aspect 1. The bearing holding device of the disclosure is a bearing holding device for holding a sliding bearing rotatably supporting a shaft including an opposing surface facing an end surface of the sliding bearing on one side in an axial direction, and a holding portion extending from the outer edge of the opposing surface toward the other side in the axial direction. The holding portion has a claw portion that restricts movement of the sliding bearing to the other side and contacts an other-side outer peripheral surface of the outer peripheral surface the sliding bearing on the other side and presses the sliding bearing inward in a radial direction to hold the sliding bearing, and a connection portion connecting the opposing surface and the claw portion to each other. A gap is provided between the connection portion and a one-side outer peripheral surface of the outer peripheral surface on the one side.

Aspect 2. In the aspect including Aspect 1 above, at least the holding portion is preferably made of resin or elastomer.

Aspect 3. In the aspect including Aspect 1 above, a support portion that restricts movement of the sliding bearing to the one side is preferably provided between the opposing surface and the end surface of the sliding bearing in the axial direction.

Aspect 4. In the aspect including Aspect 3 above, the support portion is preferably formed of an elastic member elastically deformable in the axial direction.

Aspect 5. In the aspect including Aspect 1 above, the sliding bearing is preferably an oil-impregnated bearing containing lubricant.

Aspect 6. In the aspect including Aspect 5 above, the viscosity of the lubricant at 40° C. is preferably 8 mm²/s or more and 20 mm²/s or less.

Aspect 7. In the aspect including Aspect 1 above, the sliding bearing preferably has a through-hole into which the shaft is inserted, and the through-hole preferably has a tapered shape in which the inner diameter thereof decreases toward the center in the axial direction.

Aspect 8. In the aspect including Aspect 1 above, a damping member having higher damping force than that of the holding portion is preferably interposed between the claw portion and the sliding bearing.

Aspect 9. In the aspect including Aspect 1 above, a tubular portion surrounding the holding portion from the outside of the holding portion in the radial direction is preferably provided on the outside. In this case, a damping member having higher damping force than that of the holding portion is preferably interposed between the claw portion and the tubular portion.

Aspect 10. The motor of the disclosure includes a rotor and a stator built in a housing, and a shaft rotatable integrally with the rotor, and the bearing holding device according to any one of Aspects 1 to 9 above holds a sliding bearing fixed to the housing and rotatably supporting the shaft.

### Effects of the Invention

According to the bearing holding device and motor of the disclosure, it is possible to reduce the generation of the abnormal noise around the sliding bearing.

### BRIEF DESCRIPTION OF THE DRAWINGS

FIG. 1 is an exploded perspective view of a motor to which a bearing holding device according to an embodiment is applied.

FIG. 2 is an enlarged sectional view of a portion X of FIG. 1 taken along an axial direction.

FIG. 3 is an exploded perspective view of the bearing holding device and a sliding bearing of FIG. 2.

FIG. 4 is an enlarged half sectional view of a bearing holder and a support portion of the bearing holding device of FIG. 2 and a sliding bearing, which is taken along the axial direction.

FIG. 5 is an enlarged half sectional view of a bearing holder of a bearing holding device of a first modification and a sliding bearing, which is taken along the axial direction and corresponds to the half sectional view of FIG. 4.

FIG. 6 is an enlarged half sectional view of a bearing holder of a bearing holding device of a second modification and a sliding bearing, which is taken along the axial direction and corresponds to the half sectional view of FIG. 4.

FIG. 7 is an enlarged half sectional view of a bearing holder of a bearing holding device of another example of the second modification and a sliding bearing, which is taken along the axial direction and corresponds to the half sectional view of FIG. 4.

### DESCRIPTION OF PREFERRED EMBODIMENTS

A bearing holding device and a motor will be described as an embodiment with reference to the drawings. The embodiment presented below is a mere exemplification. There is no intention to preclude various modifications and application of a technology, which are not explicitly stated in the embodiment below. The configurations of the embodiment can be modified and carried out in various manners within the scope that does not depart from the purport of the configurations. In addition, selection can be made as necessary, or combinations can be made as appropriate.

In the following description, a direction in which the center line of a shaft extends will be referred to as an axial direction, a direction orthogonal to the center line will be referred to as a radial direction, and a direction about the center line will be referred to as a circumferential direction. In the axial direction, a direction away from the center of the shaft, i.e., the center of the axial length (length in the longitudinal direction) of the shaft will be referred to as “one” side, and the opposite direction (direction toward the center of the shaft in the axial direction) thereof will be referred to as the “other” side. In the radial direction, a direction toward the center line will be referred to as “inward/inside”, and the opposite direction (direction away from the center line) thereof will be referred to as “outward/outside”.

### 1. Overall Configuration

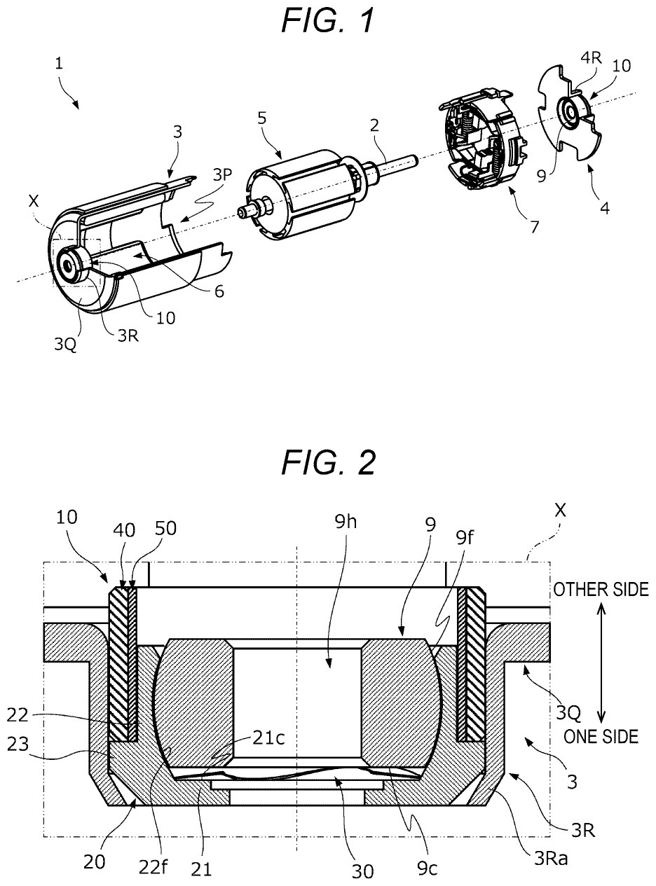

FIG. 1 is an exploded perspective view of a motor 1 to which a bearing holding device 10 (hereinafter, simply referred to as a “holding device”) of the present embodiment is applied, in which a portion where the holding device 10 is provided is partially cut out. The motor 1 is, for example, a permanent magnet field type brushed inner rotor DC motor, and includes a bottomed tubular housing 3 (fixing member) and a flat end plate 4 (fixing member) closing an opening 3P of the housing 3. The housing 3 includes therein a rotor 5 rotatable integrally with a shaft 2, and a tubular stator 6 disposed outward of the rotor 5 in the radial direction so as to face the rotor 5. A brush holder 7 supporting a brush in sliding contact with a commutator of the rotor 5 is provided between the end plate 4 and the rotor 5.

Note that the motor 1 to which the holding device 10 is applied is not limited to the brushed inner rotor motor. The motor 1 may be, for example, an outer rotor motor in which a stator 6 is disposed inward of a rotor 5 in the radial direction. The motor 1 may be a brushless motor. In this case, the brush holder 7 is unnecessary.

The shaft 2 is a rotary shaft supporting the rotor 5, and also functions as an output shaft that takes the output (mechanical energy) of the motor 1 to the outside. A bottom portion 3Q of the housing 3 is provided with a recess 3R (tubular portion) recessed in the axial direction on the inside thereof. The end plate 4 is also provided with a recess 4R (tubular portion) recessed in the axial direction on the inside thereof. Both ends of the shaft 2 are rotatably supported by sliding bearings 9 provided in the recesses 3R, 4R. The holding device 10 of the present embodiment holds the sliding bearing 9, and may be applied to each of the recess 3R of the housing 3 and the recess 4R of the end plate 4. In the following description, the holding device 10 provided for the recess 3R of the housing 3 will be described as an example, but when the holding device 10 is applied to the recess 4R of the end plate 4, a configuration similar to the configuration described below can be applied to the end plate 4.

FIG. 2 is an enlarged sectional view of a portion X of FIG. 1 taken along the axial direction. As shown in FIG. 2, the recess 3R is recessed to the one side in the axial direction from the bottom portion 3Q, and has a tubular shape having a space in which the sliding bearing 9 and the holding device 10 can be housed. In the present embodiment, the recess 3R has a substantially cylindrical shape. The inner diameter of the recess 3R is set to be slightly smaller than the outer diameter of the holding device 10, for example. Note that the shape and inner diameter of the recess 3R are not limited thereto. The shape and inner diameter of the recess 3R may be any shape as long as the shape and the inner diameter do not interfere with elastic deformation of a holding portion 22 of a bearing holder 20 of the holding device 10 described later. Note that the recess 3R may have a cylindrical shape of which the inner diameter is uniform in the axial direction, or may have a tapered shape in which the inner diameter of an end portion on the one side (hereinafter, referred to as a “tapered portion 3Ra”) decreases toward the one side as shown in the figure. A portion corresponding to the bottom surface (end surface on the one side in the axial direction) of the recess 3R may be an opening as shown in FIG. 2, or may be provided with a bottom portion in which an opening through which the shaft 2 passes is formed.

The length of the recess 3R in the axial direction is set to at least a length allowing the bearing holder 20 of the holding device 10 to be fixed inside thereof. The length of the recess 3R in the axial direction is preferably set to be larger than the length of the bearing holder 20 of the holding device 10 in the axial direction. As a result, the recess 3R surrounds the bearing holder 20 from the outside when the holding device 10 is housed therein.

The sliding bearing 9 is a component rotatably supporting the shaft 2, and has an annular shape with a through-hole 9h through which the shaft 2 is insertable. The shaft 2 is rotatably supported by the sliding bearing 9 by being inserted into the through-hole 9h. The type of sliding bearing 9 is not limited as long as the surface thereof sliding on the shaft 2 is formed of a material having self-lubricity or the sliding bearing 9 is a bearing containing lubricant for lubrication inside the surface sliding on the shaft 2.

In the present embodiment, a so-called oil-impregnated bearing impregnated with lubricant is used as the sliding bearing 9. When the shaft 2 rotates, a so-called pump action occurs, and the lubricant in the pores of the sliding bearing 9 is sucked to the outside. As a result, an oil film is formed between the sliding bearing 9 and the shaft 2 to exert a lubricating function and a cooling function. On the other hand, when the rotation of the shaft 2 is stopped, the oil in contact with the surface of the sliding bearing 9 is absorbed into the pores by a capillary action.

Here, a self-aligning bearing having an outer peripheral surface 9f formed in a spherical shape is described as an example of the sliding bearing 9. In such a sliding bearing 9, since the sliding bearing 9 is turnably held by the holding portion 22 at the spherical outer peripheral surface 9f, inclination of the axis is allowed. As a result, a self-aligning function of adjusting misalignment at the time of assembling the shaft 2 and deflection at the time of the rotation of the shaft 2 is exerted.

Note that the viscosity of the lubricant in the sliding bearing 9 is not particularly limited. However, from the viewpoint of reducing generation of abnormal noise as described later, the viscosity of the lubricant is preferably low to such an extent that the oil-impregnated bearing capable of obtaining sufficient lubricity even under low temperature environment can be configured (the function of the oil-impregnated bearing can be exerted). In addition, it is preferable that excessive outflow due to viscosity reduction does not occur even under high temperature environment. The viscosity of the lubricant at 40° C. is set to, for example, 8 mm²/s or more and 20 mm²/s or less.

The through-hole 9h may be a hole having an inner diameter into which the shaft 2 is insertable, and the inner diameter thereof may or may not be uniform in the axial direction. The through-hole 9h preferably has a tapered shape in which the inner diameter thereof decreases toward the center in the axial direction. As a result, even when the shaft 2 is inclined, normal lubrication can be obtained, and the generation of the abnormal noise described later can be reduced.

### 2. Bearing Holding Device

Hereinafter, the configuration of the holding device 10 will be described with reference to FIGS. 2 to 4. As shown in FIG. 2, the holding device 10 is provided with the bearing holder 20 fixed to the recess 3R and holding the sliding bearing 9. The holding device 10 of the present embodiment is further provided with a support portion 30 and an annular fixing member 40 (tubular portion), and is preferably also provided with a damping member 50.

Here, the sliding bearing 9 may generate the abnormal noise (for example, high-pitched noise) during the rotation of the shaft 2 depending on the state of the lubrication. In particular, under the low temperature environment, the lubricity of the sliding bearing 9 decreases (for example, the lubricant becomes harder), and for this reason, the above-described abnormal noise is likely to occur. The present inventor has found that it is effective to provide damping force to the outside of the sliding bearing 9 as a means for reducing the occurrence of such abnormal noise. Therefore, in the holding device 10 of the present embodiment, the bearing holder 20 has a configuration of exerting high damping force outside the sliding bearing 9. Further, the support portion 30 may be provided to maintain the damping force of the bearing holder 20, and the damping member 50 may be provided between the bearing holder 20 and the annular fixing member 40 to further increase the damping force outside the sliding bearing 9.

As described above, the bearing holder 20 is a member fixed to the recess 3R and holding the sliding bearing 9. The bearing holder 20 is provided with an opposing surface 21c facing a one-side end surface 9c (end surface) of the sliding bearing 9 on the one side in the axial direction, and the holding portion 22 extending from the outer edge of the opposing surface 21c toward the other side in the axial direction. In the present embodiment, the opposing surface 21c is provided at a base portion 21 on the one side with respect to the holding portion 22. The bearing holder 20 is further provided with a fixing portion 23 for fixing the bearing holder 20 to the recess 3R.

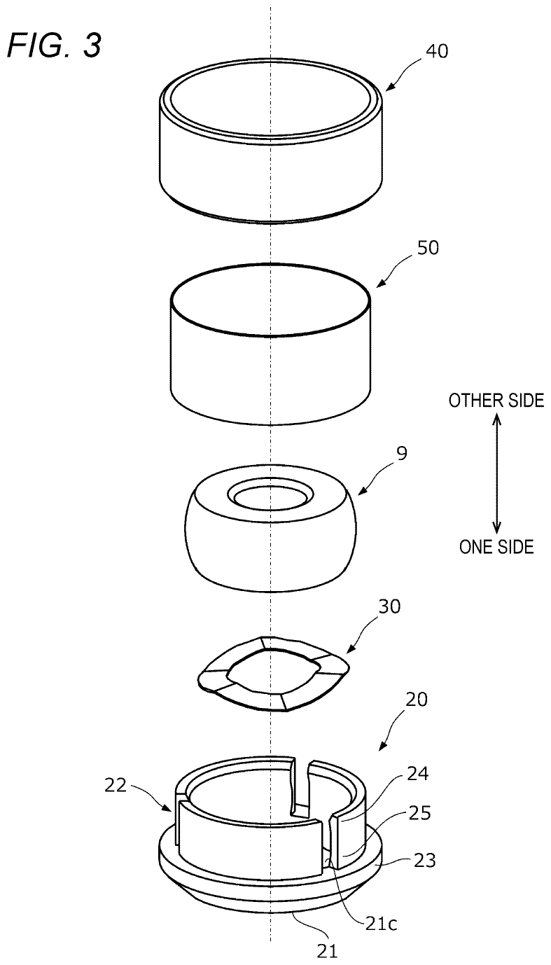

More specifically, as shown in FIGS. 2 and 3, the bearing holder 20 includes the substantially circular opposing surface 21c facing the other side in the axial direction, and the holding portion 22 having a curved wall (plate) shape extending from the outer edge (outer peripheral edge) of the opposing surface 21c to the other side and extending in the axial direction and the circumferential direction. The holding portion 22 is a portion surrounding the sliding bearing 9 from the outside in the radial direction and holding the sliding bearing 9. The sliding bearing 9 is inserted into the holding portion 22 from the other side in the axial direction, and is held by the bearing holder 20 by being restricted from moving to the other side and pressed inward by the holding portion 22. As shown in FIG. 2, the bearing holder 20 is fixed to the recess 3R by the fixing portion 23 being press-fitted into the recess 3R and being sandwiched between the tapered portion 3Ra of the recess 3R and the annular fixing member 40. The configuration of exerting the high damping force outside the sliding bearing 9 as described above is provided for the holding portion 22. In the bearing holder 20, these portions 21 to 23 are integrally made of, for example, resin or elastomer.

As described above, the base portion 21 is a portion where the opposing surface 21c is provided, and is located on the one side in the axial direction with respect to the sliding bearing 9 and has a plate shape extending in a direction intersecting the axial direction in a state of the sliding bearing 9 being held by the bearing holder 20 (hereinafter, referred to as a “holding state”). The opposing surface 21c is the surface of the plate-shaped base portion 21 facing the other side in the axial direction, and in the holding state, faces the one-side end surface 9c of the end surfaces of the sliding bearing 9 facing the one side.

In the present embodiment, the base portion 21 extends in a direction orthogonal to the axial direction, and is defined as a portion of the bearing holder 20 on the one side with respect to the position of the opposing surface 21c in the axial direction. Therefore, the opposing surface 21c has a planar shape extending in the direction orthogonal to the axial direction. Note that the opposing surface 21c only needs to be the surface facing the one-side end surface 9c of the sliding bearing 9 in the holding state, and does not necessarily have the planar shape.

In the present embodiment, the base portion 21 has a circular outer shape having an outer diameter larger than the outer diameter of the sliding bearing 9 as viewed in the axial direction. The base portion 21 may or may not have a uniform outer diameter in the axial direction. As shown in the figure, the outer peripheral surface of the base portion 21 may have a tapered shape in which the outer diameter thereof decreases toward the one side in accordance with the shape of the inner peripheral surface of the tapered portion 3Ra of the recess 3R described above.

In addition, the base portion 21 is provided with an inner hole through which the shaft 2 is insertable on the inside thereof, and therefore, the base portion 21 has a circular ring shape as viewed in the axial direction. Therefore, the opposing surface 21c also has a circular ring shape as viewed in the axial direction. The size of the inner hole of the base portion 21 is set at least to be smaller than the outer diameter of the one-side end surface 9c and to be larger than the outer diameter of the shaft 2. Note that the inner hole of the base portion 21 may not have the uniform inner diameter in the axial direction, and may have a stepped shape in which the inner diameter on the other side is larger than the inner diameter on the one side as shown in the figure.

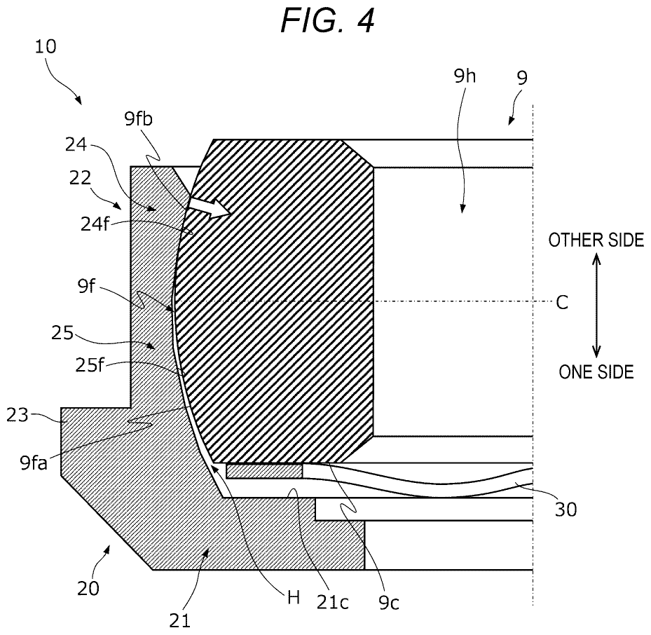

As described above, the holding portion 22 is a wall-shaped portion extending from the outer edge of the opposing surface 21c toward the other side in the axial direction, and forms the space for housing (holding) the sliding bearing 9 on the inside in the radial direction The holding portion 22 can also be said to be a portion surrounding the sliding bearing 9 from the outside in the radial direction in the holding state, and has a claw portion 24 and a connection portion 25 as shown in FIGS. 3 and 4.

As shown in FIG. 4, the claw portion 24 is a portion which contacts a portion (hereinafter, referred to as an “other-side outer peripheral surface 9fb”) of the outer peripheral surface 9f of the sliding bearing 9 on the other side in the holding state to restrict movement of the sliding bearing 9 to the other side and to press (bias) the sliding bearing 9 inward. For example, in the holding state, the claw portion 24 is located on the other side with respect to the center C of the sliding bearing 9 in the axial direction, and extends in the circumferential direction as shown in FIG. 3. As shown in FIG. 4, the claw portion 24 forms an inner peripheral surface (hereinafter, referred to as an “other-side inner peripheral surface 24f”) which faces inward and surrounds the other-side outer peripheral surface 9fb. In the present embodiment, the other-side inner peripheral surface 24f has a hemispherical shape of which the inner diameter decreases toward the other side in accordance with the shape of the other-side outer peripheral surface 9fb. The inner diameter of the other-side inner peripheral surface 24f is set to be smaller than the outer diameter of the other-side outer peripheral surface 9fb in a state of the sliding bearing 9 being not held by the bearing holder 20 (hereinafter, referred to as a “non-holding state”).

As a result, in the holding state, the holding portion 22 elastically deforms such that the claw portion 24 is displaced outward with a connection portion with the opposing surface 21c (base portion 21) as a base point. The claw portion 24 comes into contact with the other-side outer peripheral surface 9fb from the outside and the other side by force (restoring force) of returning the holding portion 22 to an original state, and presses the sliding bearing 9 inward and toward the one side as indicated by a white arrow in FIG. 4. The sliding bearing 9 is restricted from moving to the other side and is pressed (biased) inward by the pressing force of the claw portion 24.

The connection portion 25 is a portion connecting the claw portion 24 and the opposing surface 21c to each other, and extends in the circumferential direction similarly to the claw portion 24. The connection portion 25 forms a one-side inner peripheral surface 25f facing inward and surrounding a portion (hereinafter, referred to as a “one-side outer peripheral surface 9fa”) of the outer peripheral surface 9f of the sliding bearing 9 on the one side. The edge of the one-side inner peripheral surface 25f on the one side is connected to the outer edge of the opposing surface 21c. In the present embodiment, the one-side inner peripheral surface 25f has a hemispherical shape of which the inner diameter decreases toward the one side in accordance with the shape of the one-side outer peripheral surface 9fa.

In the holding state, the claw portion 24 described above contacts the other-side outer peripheral surface 9fb of the sliding bearing 9, whereas the connection portion 25 does contact the one-side outer peripheral surface 9fa of the sliding bearing 9 and is disposed so as to face the one-side outer peripheral surface 9fa through a gap H. In other words, the gap H is provided between the connection portion 25 and the one-side outer peripheral surface 9fa of the sliding bearing 9. In order to form such a gap H, in the holding portion 22, the inner diameter of the connection portion 25 is set to be slightly larger than the outer diameter of the one-side outer peripheral surface 9fa. In FIG. 4, the gap H is shown to be large for the sake of easy understanding, but the gap H is preferably set to be narrow to such an extent that rattling of the sliding bearing 9 does not occur in the holding state. The size of the gap H is set to several tens of μm, for example.

Note that as shown in the figure, the one-side outer peripheral surface 9fa of the sliding bearing 9 may include not only a portion of the outer peripheral surface 9f on the one side, but also a peripheral surface excluding the other-side outer peripheral surface 9fb (i.e., portion in the vicinity of the center C). In the present embodiment, the claw portion 24 located on the other side with respect to the center C of the sliding bearing 9 in the holding state is described as an example. On the other hand, in a case where the claw portion 24 extends from the vicinity of the center C of the sliding bearing 9 to the other side, the other-side outer peripheral surface 9fb of the sliding bearing 9 may include not only a portion of the outer peripheral surface 9f on the other side (the other side with respect to the center C of the sliding bearing 9), but also a portion in the vicinity of the center C of the sliding bearing 9.

That is, here, in the outer peripheral surface 9f of the sliding bearing 9, a peripheral surface which is located on the other side with respect to the one-side outer peripheral surface 9fa and with which the claw portion 24 contacts is defined as the other-side outer peripheral surface 9fb, and a peripheral surface which is located on the one side with respect to the other-side outer peripheral surface 9fb and is provided with the gap H between the connection portion 25 and such a peripheral surface is defined as the one-side outer peripheral surface 9fa. In the holding portion 22, a portion located on the other side with respect to the connection portion 25 and contacting the outer peripheral surface 9f (other-side outer peripheral surface 9fb) of the sliding bearing 9 is defined as the claw portion 24, and a portion located on the one side with respect to the claw portion 24 and provided with the gap H between the outer peripheral surface 9f (one-side outer peripheral surface 9fa) of the sliding bearing 9 and such a portion is defined as the connection portion 25. In a case where the fixing portion 23 is provided for the bearing holder 20, the claw portion 24 may be provided separately from the fixing portion 23 to the other side by a predetermined dimension or more without overlapping with the fixing portion 23 at least in the axial direction.

Since the gap H is provided between the connection portion 25 and the one-side outer peripheral surface 9fa of the sliding bearing 9, the sliding bearing 9 is allowed to displace in the radial direction by an amount corresponding to the gap H in the holding state. Therefore, when the sliding bearing 9 displaces during the rotation of the shaft 2, the holding portion 22 is elastically deformed so as to bend by such displacement, and the restoring force of the holding portion 22 acts on the sliding bearing 9 through the claw portion 24. Therefore, the damping force is generated outside the sliding bearing 9, and the abnormal noise is reduced. That is, the holding portion 22 of the present embodiment is configured to be more easily bent by the claw portion 24 and the connection portion 25 described above according to the displacement of the sliding bearing 9 in the radial direction. As described above, by flexibly holding the sliding bearing 9 by the holding portion 22, high damping force is exerted outside the sliding bearing 9. The dimension (thickness) of the connection portion 25 in the radial direction is set to a size allowing the displacement (i.e., the elastic deformation of the holding portion 22 described above) of the claw portion 24.

Note that the holding portion 22 may not have the tubular shape surrounding the entire outer peripheral surface 9f of the sliding bearing 9 in the circumferential direction, but may have a shape in which the tube is divided in the circumferential direction, i.e., a shape in which a plurality of curved wall-shaped (plate-shaped) portions is arranged with a gap in the circumferential direction. For example, as shown in FIG. 3, the holding portion 22 may have a shape obtained by dividing a substantially cylinder into three in the circumferential direction. The holding portion 22 in FIG. 3 includes three partially-cylindrical (arc shape as viewed in the axial direction) pieces (wall-shaped portions) provided apart from each other (with a gap) in the circumferential direction and standing on the base portion 21.

As described above, by dividing the holding portion 22 into the plurality of pieces, each piece can be deformed independently when the force is applied to each piece forming the holding portion 22. Therefore, the sliding bearing 9 can be easily inserted into the bearing holder 20, and each piece can be flexibly and elastically deformed along with the displacement of the sliding bearing 9 in the holding state. Further, the moldability of the bearing holder 20 is improved.

As shown in FIG. 4, the fixing portion 23 is a substantially cylindrical portion bulging outward from the outer peripheral surface of the holding portion 22 on the one side (for example, the one side of the connection portion 25). The outer diameter of the fixing portion 23 is set to be slightly larger than the inner diameter of the recess 3R. The outer peripheral surface of the fixing portion 23 may or may not have a uniform outer diameter in the axial direction. As shown in the figure, the outer peripheral surface of the fixing portion 23 may have a tapered shape in which the outer diameter of a portion on the one side decreases toward the one side and is connected to the outer peripheral surface of the base portion 21.

Note that the position of the fixing portion 23 in the axial direction is not limited to the one side of the connection portion 25. The fixing portion 23 may be provided at least at a position not interfering with at least the displacement of the claw portion 24 (elastic deformation of the holding portion 22) in the radial direction.

As described above, the annular fixing member 40 is the member fixing the bearing holder 20 by sandwiching the fixing portion 23 between the annular fixing member 40 and the tapered portion 3Ra of the recess 3R. The annular fixing member 40 is, for example, a cylindrical metal ring having an outer diameter slightly larger than the inner diameter of the recess 3R and an inner diameter larger than the outer diameter of the holding portion 22. As a result, as shown in FIG. 2, the annular fixing member 40 is press-fitted and fixed in the recess 3R on the other side of the fixing portion 23. The bearing holder 20 is fixed by sandwiching the fixing portion 23 between the press-fitted and fixed annular fixing member 40 and the tapered portion 3Ra. The holding portion 22 of the bearing holder 20 is surrounded by the annular fixing member 40, and the gap is formed between the holding portion 22 and the annular fixing member 40. Note that the inner diameter of the annular fixing member 40 is set to a size capable of forming a sufficient gap between the holding portion 22 and the annular fixing member 40 so as not to interfere with the elastic deformation of the holding portion 22 described above.

As described above, the support portion 30 is the member that maintains the damping force of the bearing holder 20. The support portion 30 is provided between the base portion 21 and the sliding bearing 9 in the axial direction, and restricts movement of the sliding bearing 9 to the one side. In the present embodiment, the support portion 30 is provided separately from the bearing holder 20, and is formed of an elastic member which is different from the bearing holder 20 and is elastically deformable in the axial direction. Specifically, as shown in FIG. 3, a wave washer obtained by processing a steel plate having an annular shape (for example, thin disk shape) as viewed in the axial direction so as to have a wave shape as viewed in the radial direction is used as the support portion 30. As shown in FIG. 2, the support portion 30 is sandwiched between the opposing surface 21c of the base portion 21 and the one-side end surface 9c of the sliding bearing 9 in the holding state.

As described above, the damping member 50 is the member that further increases the damping force outside the sliding bearing 9, and is formed of the member having the damping force higher than that of the bearing holder 20. In the present embodiment, the damping member 50 is a rubber sheet, and is interposed in the gap between the holding portion 22 of the bearing holder 20 and the annular fixing member 40. The damping member 50 has, for example, a cylindrical shape having an inner diameter equal to the outer diameter of the holding portion 22 or slightly smaller than the outer diameter of the holding portion 22. The damping member 50 is interposed in a state of being compressed in the thickness direction of the rubber sheet, i.e., in a state of being slightly expanded in diameter, and contacts the holding portion 22. As a result, since the damping member 50 is immediately compressed in the thickness direction according to the above-described elastic deformation of the holding portion 22, the damping force of the damping member 50 acts on the sliding bearing 9 in addition to the damping force of the holding portion 22. Therefore, the damping force outside the sliding bearing 9 is increased.

The outer diameter of the damping member 50 is preferably set to be equal to the inner diameter of the annular fixing member 40 or slightly larger than the inner diameter of the annular fixing member 40. As a result, since the damping member 50 is more reliably compressed according to the elastic deformation of the holding portion 22, the damping force outside the sliding bearing 9 is increased. Note that the outer diameter of the damping member 50 may be set to be smaller than the inner diameter of the annular fixing member 40. In this case, the gap is formed outside the damping member 50, i.e., between the damping member 50 and the annular fixing member 40, but the damping force is generated by extending the ring-shaped (cylindrical) rubber sheet outward according to the elastic deformation of the holding portion 22. That is, the outer diameter of the damping member 50 may be at least a diameter allowing the damping member 50 to be interposed in the gap between the holding portion 22 and the annular fixing member 40.

### 3. Features, Effects

(1) In the holding device 10 and the motor 1 described above, the opposing surface 21c facing the one-side end surface 9c of the sliding bearing 9 and the holding portion 22 extending from the outer edge of the opposing surface 21c toward the other side in the axial direction are provided. The holding portion 22 has the claw portion 24 and the connection portion 25 connecting the opposing surface 21c and the claw portion 24 to each other. The claw portion 24 restricts the movement of the sliding bearing 9 to the other side, and contacts the other-side outer peripheral surface 9fb of the sliding bearing 9 and presses the sliding bearing 9 inward in the radial direction to hold the sliding bearing 9. The gap H is provided between the connection portion 25 and the one-side outer peripheral surface 9fa of the sliding bearing 9. With such a configuration, the high damping force can be exerted outside the sliding bearing 9, and therefore, the generation of the abnormal noise around the sliding bearing 9 can be reduced.

Specifically, as in the bearing holding device disclosed in Patent Literature 1, in a device having a holding claw portion standing on a disk-shaped bottom portion and holding a bearing by closely fitting the bearing into the substantially spherical inner peripheral surface of the holding claw portion, outward movement of the bearing is restricted (limited) in the vicinity of the base of the holding claw portion (in the vicinity of a connection portion with the bottom portion). Therefore, even if the bearing receives force from a shaft, the holding claw portion is less likely to move flexibly (the holding claw portion is less likely to bend), and therefore, it is difficult to obtain sufficient damping performance.

On the other hand, in the holding device 10 described above, when the sliding bearing 9 receives the force from the shaft 2, the displacement of the sliding bearing 9 in the radial direction is allowed by the amount corresponding to the gap H. As a result, the holding portion 22 can be more greatly elastically deformed with the base (connection portion 25) as the base point. In other words, a large loss due to the elastic deformation of the holding portion 22 can be obtained. Therefore, since the high damping force can be exerted outside the sliding bearing 9, for example, even if the sliding bearing 9 vibrates, the vibration can be reduced, and the generation of the abnormal noise around the sliding bearing 9 can be reduced.

(2) In the holding device 10 described above, the bearing holder 20 having the holding portion 22 is made of resin or elastomer. As described above, by forming the holding portion 22 using the material having damping performance resulting in a larger loss than that of metal and more attenuation of vibration, it is possible to increase the damping force acting on the outside of the sliding bearing 9.

(3) The holding device 10 described above is provided with the support portion 30 provided between the opposing surface 21c and the one-side end surface 9c of the sliding bearing 9 in the axial direction and restricting the movement of the sliding bearing 9 to the one side. With such a support portion 30, the sliding bearing 9 can be separated (floated) to the other side with respect to the opposing surface 21c in the holding state. Therefore, the gap H between the connection portion 25 and the one-side outer peripheral surface 9fa of the sliding bearing 9 is more easily maintained, so that the damping force outside the sliding bearing 9 can be maintained.

In particular, when the claw portion 24 is pressed from the outside and the other side against the sliding bearing 9 having the spherical outer peripheral surface 9f as indicated by the white arrow in FIG. 4 as in the holding device 10 described above, the sliding bearing 9 is pressed to the one side, and the one-side inner peripheral surface 25f of the connection portion 25 and the one-side outer peripheral surface 9fa of the sliding bearing 9 can contact each other. In the holding device 10 described above, since the movement of the sliding bearing 9 to the one side is restricted by the support portion 30, the gap H between the connection portion 25 and the one-side outer peripheral surface 9fa is more easily maintained. Therefore, the damping force outside the sliding bearing 9 can be maintained, and therefore, the generation of the abnormal noise around the sliding bearing 9 can be reduced.

(4) Furthermore, in the holding device 10 described above, the support portion 30 is formed of the elastic member elastically deformable in the axial direction. As a result, it is possible to appropriately maintain the gap H between the connection portion 25 and the one-side outer peripheral surface 9fa while allowing the slight displacement of the sliding bearing 9 in the axial direction. Therefore, the normal lubrication of the sliding bearing 9 can be obtained, and the generation of the abnormal noise around the sliding bearing 9 can be reduced.

In particular, when the self-aligning bearing having the spherical outer peripheral surface 9f is used as the sliding bearing 9, the axial direction of the sliding bearing 9 changes according to the inclination of the shaft 2 in order to exert the self-aligning function. Accordingly, the one-side end surface 9c of the sliding bearing 9 is also displaced (the direction of the one-side end surface 9c is also changed). When even the slight displacement of the sliding bearing 9 in the axial direction is not allowed, the displacement of the one-side end surface 9c as described above is not allowed, and there is a possibility that the self-aligning function is not sufficiently exerted.

However, in the holding device 10 described above, since the support portion 30 is formed of the elastic member, it is possible to maintain the gap H between the connection portion 25 and the one-side outer peripheral surface 9fa while allowing the slight displacement of the one-side end surface 9c of the sliding bearing 9. When the sliding bearing 9 is inclined, the elastically deformable support portion 30 (wave washer) acts to return the inclined sliding bearing 9 to the original state. Therefore, the self-aligning function of the sliding bearing 9 can be assisted. As a result, it is possible to achieve all the reduction in the generation of the abnormal noise around the sliding bearing 9, the normal lubrication of the sliding bearing 9, and the function of assisting the self-aligning function of the sliding bearing 9.

(5) In the holding device 10 described above, the oil-impregnated bearing is used as the sliding bearing 9. In the oil-impregnated bearing, as described above, the lubricating function for the rotation of the shaft 2 is exerted by the lubricant being sucked to the outside by the rotation of the shaft 2. However, under the low temperature environment, since the lubricant is hard as described above, the lubricant is less likely to be sucked to the outside even if the shaft 2 rotates, and the abnormal noise is likely to occur. Even with such a sliding bearing 9, the generation of the abnormal noise around the sliding bearing 9 can be reduced even in the above-described situation by applying the holding device 10 described above.

(6) In addition, by setting the viscosity of the lubricant at 40° C. to a relatively low viscosity of 8 mm²/s or more and 20 mm²/s or less, the generation of the abnormal noise around the sliding bearing 9 can be more appropriately reduced.

(7) The shear force of the lubricant contained in the sliding bearing 9 is determined according to the viscosity (hardness) of the lubricant, the area to which the shear force is applied, the rotation speed of the shaft 2, and the size of the clearance (gap) between the sliding bearing 9 and the shaft 2. The inventor has found that the abnormal noise generated around the sliding bearing 9 tends to be reduced as the shearing force of the lubricant is smaller. In a case where the through-hole 9h of the sliding bearing 9 has the tapered shape of which the inner diameter decreases toward the center C in the axial direction, the area of a portion where the clearance between the sliding bearing 9 and the shaft 2 decreases can be further decreased. In other words, a wider area of a portion where the clearance larger than the clearance in the vicinity of the center C in the axial direction is formed can be ensured in the through-hole 9h. As a result, it is possible to reduce the shearing force of the lubricant in the portion other than the vicinity of the center C in the axial direction, and therefore, it is possible to further reduce the generation of the abnormal noise around the sliding bearing 9.

(8) In the holding device 10 described above, the annular fixing member 40 (tubular portion) surrounding the holding portion 22 is provided outside the holding portion 22. In addition, the damping member 50 having the damping force higher than that of the holding portion 22 is interposed between the holding portion 22 and the annular fixing member 40. As a result, both the damping force of the holding portion 22 and the damping force of the damping member 50 are exerted outside the sliding bearing 9, so that higher damping force can be provided outside the sliding bearing 9. Therefore, the generation of the abnormal noise can be further reduced.

### 4. First Modification

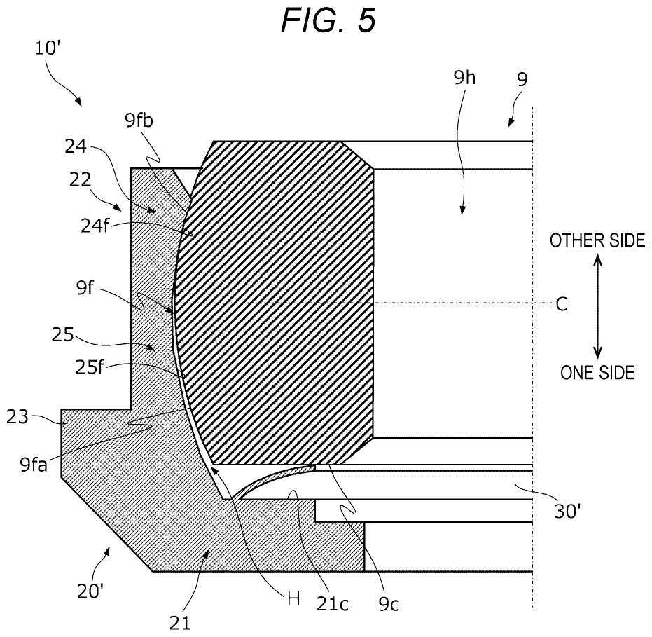

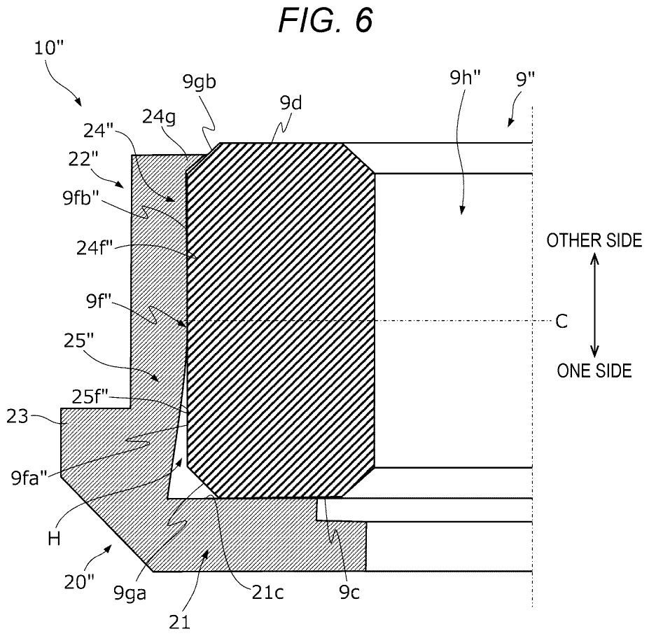

The configuration of the holding device 10 described above is an example, and is not limited to the above-described configuration. In the holding device 10 described above, the support portion 30 is provided as a member different from the bearing holder 20, but the support portion may be configured integrally with the bearing holder. Hereinafter, a holding device 10′ of a first modification will be described with reference to FIG. 5. The holding device 10′ of the first modification differs from the holding device 10 of the example (embodiment described above) mainly in that a support portion 30′ is provided integrally with a bearing holder 20′.

FIG. 5 is an enlarged half sectional view of the bearing holder 20′ of the holding device 10′ of the first modification and the sliding bearing 9, which is taken along the axial direction. In the following description, the same reference signs are assigned to the same configurations as those described in the example, and descriptions of the configurations and effects thereof are omitted. Moreover, in terms of configurations corresponding to the configurations described in the example, the prime symbol (′) is provided to the reference numerals in the example, and detailed description thereof is omitted.

As shown in FIG. 5, the bearing holder 20′ of the holding device 10′ of the first modification is provided with the support portion 30′ in addition to the base portion 21 having the opposing surface 21c, the holding portion 22, and the fixing portion 23 as described above. The support portion 30′ is formed in a leaf spring shape extending inward and toward the other side from the outside of the opposing surface 21c of the base portion 21. The position of an inner end portion of the support portion 30′ in the axial direction is set, in the non-holding state, to be on the other side with respect to the position of the one-side end surface 9c of the sliding bearing 9 in the axial direction in the holding state. As a result, in the holding state, the inner end portion of the support portion 30′ is pressed to the one side by the sliding bearing 9, and the support portion 30′ is elastically deformed. The sliding bearing 9 is restricted from moving to the one side and is biased to the other side by the restoring force of the support portion 30′.

Also in the holding device 10′ of the first modification, effects similar to those of the holding device 10 described above can be obtained. In addition, in the holding device 10′ of the present modification, since the support portion 30′ is provided integrally with the bearing holder 20′, the number of components can be reduced.

### 5. Second Modification

In the holding device 10 described above, the self-aligning bearing having the spherical outer peripheral surface 9f has been described as the example of the sliding bearing 9 held by the holding device 10, but the sliding bearing may have a cylindrical outer peripheral surface having no self-aligning function. Hereinafter, a holding device 10″ of a second modification will be described with reference to FIG. 6. The holding device 10″ of the second modification differs from the holding device 10 of the embodiment mainly in that a sliding bearing 9″ having a cylindrical outer peripheral surface 9f″ is held and no support portion 30 is provided.

FIG. 6 is an enlarged half sectional view of a bearing holder 20″ of the holding device 10″ of the second modification and the sliding bearing 9″, which is taken along the axial direction. In the following description, the same reference signs are assigned to the same configurations as those described in the example, and descriptions of the configurations and effects thereof are omitted. Moreover, in terms of configurations corresponding to the configurations described in the example, the double quotation (″) is provided to the reference numerals in the example, and detailed description thereof is omitted.

As described above, the sliding bearing 9″ held by the holding device 10″ of the second modification is the bearing having the cylindrical outer peripheral surface 9f″. The outer diameter of the outer peripheral surface 9f″ is, for example, uniform in the axial direction. The sliding bearing 9″ is provided with the one-side end surface 9c and an other-side end surface 9d of the end surfaces of the sliding bearing 9″ facing the other side. The sliding bearing 9″ is provided with a one-side tapered surface 9ga connecting the one-side end surface 9c and the outer peripheral surface 9f″ to each other and an other-side tapered surface 9gb connecting the other-side end surface 9d and the outer peripheral surface 9f″ to each other.

Similarly to the through-hole 9h described above, the through-hole 9h″ of the sliding bearing 9″ may have a tapered shape in which the inner diameter thereof decreases toward the center C in the axial direction. In this case, the generation of the abnormal noise can be further reduced, and even if the sliding bearing 9″ itself does not have the self-aligning function, the slight inclination of the shaft 2 can be allowed by the shape of the through-hole 9h″, and therefore, normal lubricating performance can be obtained even if the shaft 2 is inclined.

The bearing holder 20″ of the holding device 10″ includes the holding portion 22″ as a portion for holding such a sliding bearing 9″. Similarly to the holding portion 22 described above, the holding portion 22″ is a portion extending from the opposing surface 21c to the other side, and includes the claw portion 24″ and the connection portion 25″. Note that in the present modification, the support portion 30 provided for the holding device 10 of the example is omitted, and the one-side end surface 9c of the sliding bearing 9″ contacts the opposing surface 21c in the holding state.

Similarly to the claw portion 24 described above, the claw portion 24″ is a portion contacting the other-side outer peripheral surface 9fb″ of the sliding bearing 9″ in the holding state and pressing (biasing) the sliding bearing 9″ inward. The claw portion 24″ faces inward, and forms the other-side inner peripheral surface 24f″ surrounding the other-side outer peripheral surface 9fb″. The other-side inner peripheral surface 24f″ has an inner diameter slightly smaller than the outer diameter of the other-side outer peripheral surface 9fb″ in the non-holding state. The claw portion 24″ is provided with a restricting portion 24g forming a surface facing the one side and inward on the other side with respect to the other-side inner peripheral surface 24f″. The claw portion 24″ restricts the movement of the sliding bearing 9″ to the other side when the above-described surface of the restricting portion 24g contacts the other-side tapered surface 9gb of the sliding bearing 9″ in the holding state.

Note that in the second modification, as shown in the figure, the claw portion 24″ extending from the vicinity of the center C of the sliding bearing 9″ to the other side is shown as an example. That is, the other-side inner peripheral surface 24f″ contacts a portion of the outer peripheral surface 9f″ on the other side, which includes the vicinity of the center C, and the other-side outer peripheral surface 9fb″ of the sliding bearing 9″ includes not only a portion of the outer peripheral surface 9f′″ on the other side (other side with respect to the center C of the sliding bearing 9″), but also a portion in the vicinity of the center C of the sliding bearing 9″. However, the claw portion 24″ only needs to be provided apart from the fixing portion 23 to the other side by the predetermined dimension or more without overlapping with the fixing portion 23 at least in the axial direction, and may extend from the one side with respect to the vicinity of the center C of the sliding bearing 9″ to the other side including the vicinity of the center C and may extend from the other side with respect to the center C of the sliding bearing 9″ to the other side.

Similarly to the connection portion 25 described above, the connection portion 25″ is a portion connecting the claw portion 24″ and the opposing surface 21c to each other, and forms the one-side inner peripheral surface 25f″ facing inward and surrounding the one-side outer peripheral surface 9fa″ of the sliding bearing 9″. The inner diameter of the one-side inner peripheral surface 25f″ is set to be larger than the outer diameter of the one-side outer peripheral surface 9fa″ in order to form the gap H between the one-side outer peripheral surface 9fa″ and the one-side inner peripheral surface 25f″ in the holding state. Note that the inner diameter of the one-side inner peripheral surface 25f″ may be uniform in the axial direction, or may be slightly increased toward the one side as shown in the figure. The connection portion 25″ may be provided so as to also form a gap between the connection portion 25″ and the one-side tapered surface 9ga″ of the sliding bearing 9″. The connection portion 25″ may form the gap H at least in a region overlapping with the fixing portion 23 in the axial direction.

Also in the holding device 10″ of the second modification as shown in FIG. 6, effects similar to those of the holding device 10 described above can be obtained. That is, in the holding device 10″, when the sliding bearing 9″ receives the force from the shaft 2, the displacement of the sliding bearing 9″ in the radial direction is allowed by the amount corresponding to the gap H. As a result, since the loss corresponding to the displacement amount acts on the holding portion 22″, the damping force of the holding portion 22″ can be increased, and the generation of the abnormal noise around the sliding bearing 9″ can be reduced.

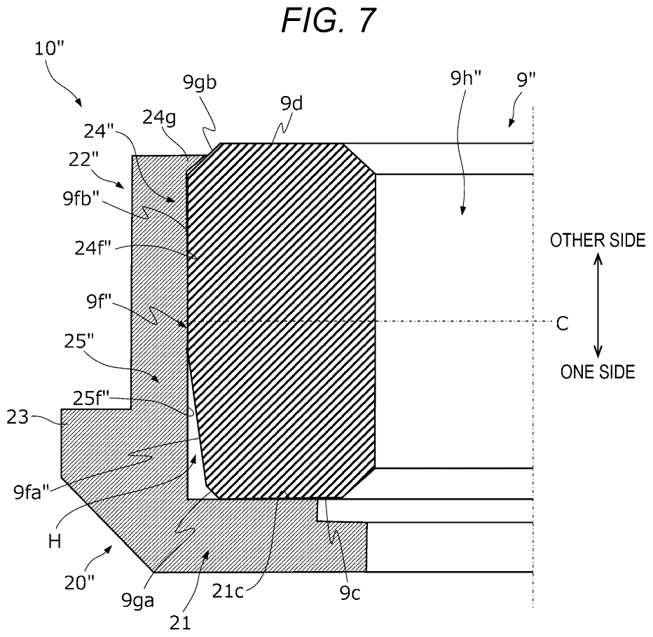

Note that the holding device 10″ of the second modification is an example, and is not limited to that shown in FIG. 6. FIG. 7 is an enlarged half sectional view of a bearing holder 20″ of a holding device 10″ of another example of the second modification and a sliding bearing 9″, which is taken along the axial direction. As shown in FIG. 7, in the holding device 10″ of the other example, the one-side outer peripheral surface 9fa″ of the sliding bearing 9″ is slightly reduced in diameter toward the one side, and therefore, the gap H is formed between the connection portion 25″ and the one-side outer peripheral surface 9fa″. That is, when the cylindrical sliding bearing 9″ is held, the member to be released (the shape thereof is devised) to ensure the gap H may be the sliding bearing 9″ instead of the bearing holder 20″. In this case, the inner diameter of the one-side inner peripheral surface 25f″ of the connection portion 25″ may be uniform in the axial direction. Also in the holding device 10″ of the other example shown in FIG. 7, effects similar to those of FIG. 6 can be obtained.

### 6. Others

The configurations of the holding device 10, 10′, 10″ and the motor 1 described above are an example, and are not limited to the above-described configurations. The sliding bearings 9, 9″ is not limited to the oil-impregnated bearing, and may be any sliding bearing.

The bearing holder 20, 20′, 20″ only needs to be made of the material exhibiting at least the damping performance, and may not be made of resin or elastomer. In the bearing holder 20, 20′, 20″, at least the holding portion 22, 22″ may be made of the material exhibiting the damping performance, and the base portion 21, the fixing portion 23, and the support portion 30′ may be made of materials different from that of the holding portion 22, 22″.

The opposing surface 21c may be at least the surface facing the one-side end surface 9c of the sliding bearing 9, 9″, and may not have the flat plate shape or the annular shape. The shape of the base portion 21 provided with the opposing surface 21c is also not limited to the above-described shape. The bearing holder 20, 20′, 20″ may be provided with a portion engaging with the recess 3R, 4R instead of the fixing portion 23. The bearing holder 20, 20′, 20″ may not be fixed to the housing 3 or the end plate 4, and may be formed integrally with the housing 3 or the end plate 4.

For the holding device 10 of the embodiment and the holding device 10″ of the second modification, the wave washer has been described as the example of the support portion 30 provided separately from the bearing holder 20, 20″ and formed of the elastic member elastically deformable in the axial direction, but the support portion 30 may not be the wave washer. The support portion 30 may be, for example, a spring member stretchable and contractable in the axial direction, or may be a ring made of rubber (rubber ring). In a case where the support portion 30 is formed of the rubber ring, damping force higher than that of the metal wave washer can be obtained.

In a case where the holding device 10, 10′ does not require the self-aligning function of the sliding bearing 9, the support portion 30, 30′ may not be the elastic member elastically deformable in the axial direction. In this case, the support portion 30, 30′ may be, for example, a protrusion protruding from the opposing surface 21c of the base portion 21. Note that the support portion 30, 30′ may be omitted when the holding device 10, 10′ do not require the self-aligning function of the sliding bearing 9. In this case, the one-side end surface 9c of the sliding bearing 9 may contact the opposing surface 21c of the base portion 21 in the holding state, similarly to the holding device 10″ of the second modification. Note that the holding device 10″ of the second modification may be provided with the support portion 30, 30′ described above.

The method of fixing the annular fixing member 40 to the recess 3R, 4R is not limited to the press-fitting. The annular fixing member 40 may be fixed to the recess 3R, 4R so as to exert at least a function of fixing the bearing holder 20, 20′, 20″, and may be fixed by caulking or welding, for example. Note that the annular fixing member 40 may be omitted when the bearing holder 20, 20′, 20″ is formed integrally with the housing 3 or the end plate 4 by, for example, integral molding or processing with a 3D printer, and has a structure of not moving relative to the housing 3 or the end plate 4. In this case, the damping member 50 may be interposed between the holding portion 22, 22″ and the recess 3R, 4R. That is, the “tubular portion surrounding the holding portion from the outside” described in the claims is not limited to the annular fixing member 40, and may be the recess 3R of the housing 3 or the recess 4R of the end plate 4. The “tubular portion” may be formed integrally with the bearing holder 20, 20′, 20″.

In the holding device 10, 10′, 10″ described above, the damping member 50 has been described as having the inner diameter slightly smaller than the outer diameter of the holding portion 22, 22″, but the inner diameter of the damping member 50 is not limited thereto. The damping member 50 may have an inner diameter slightly larger than the outer diameter of the holding portion 22, 22″, and form a slight gap between the damping member 50 and the holding portion 22, 22″. In this case, the above-described elastic deformation of the holding portion 22, 22″ is less likely to be interfered by the damping member 50, and in a case where the holding portion 22, 22″ is greatly deformed, the damping force of the damping member 50 acts on the sliding bearing 9, 9″ in addition to the damping force of the holding portion 22, 22″ by the holding portion 22, 22″ contacting the damping member 50. Therefore, the damping force outside the sliding bearing 9, 9″ is increased.

The damping member 50 interposed between the holding portion 22, 22″ and the annular fixing member 40 may be omitted. Instead of or in addition to such a damping member 50, the holding device 10, 10′, 10″ may be provided, between the claw portion 24, 24″ and the sliding bearing 9, 9″, with a damping member having damping force higher than that of the holding portion 22, 22″. The damping member is the component separated from the damping member 50, and may be made of the same material or a different material. According to such a configuration, higher damping force can be given to the outside of the sliding bearing 9, 9″.

The holding device 10, 10′, 10″ only need to hold at least the sliding bearing 9, 9″ supporting the rotating shaft 2, and the device to which the holding device 10, 10′, 10″ is applied is not limited to the motor. The device (rotary machine) to which the holding device 10, 10′, 10″ is applied may be, for example, an engine.

### DESCRIPTION OF REFERENCE SIGNS

1 Motor
2 Shaft
3 Housing (fixing member)
3R Recess (tubular portion)
4 End plate (fixing member)
4R Recess (tubular portion)
5 Rotor
6 Stator
9, 9″ Sliding bearing
9c One-side end surface (end surface)
9f, 9f″ Outer peripheral surface
9fa, 9fa″ One-side outer peripheral surface
9fb, 9fb″ Other-side outer peripheral surface
9h, 9h″ Through-hole
10, 10′, 10″ Holding device (bearing holding device)
20, 20′, 20″ Bearing holder
21c Opposing surface
22, 22″ Holding portion
24, 24″ Claw portion
24f, 24f″ Other-side inner peripheral surface
25, 25″ Connection portion
25f, 25f″ One-side inner peripheral surface
30, 30′ Support portion
40 Annular fixing member (tubular portion)
50 Damping member
H Gap

1. A bearing holding device for holding a sliding bearing that rotatably supports a shaft, comprising:
an opposing surface facing an end surface of the sliding bearing on one side in an axial direction; and
a holding portion extending from an outer edge of the opposing surface toward the other side in the axial direction, wherein
the holding portion has
a claw portion that restricts movement of the sliding bearing toward the other side and comes into contact with an other-side outer peripheral surface of an outer peripheral surface of the sliding bearing on the other side to press the sliding bearing inward in a radial direction, and
a connection portion connecting the opposing surface and the claw portion to each other, and
a gap is provided between the connection portion and a one-side outer peripheral surface of the outer peripheral surface on the one side.

2. The bearing holding device according to claim 1, wherein at least the holding portion is made of resin or elastomer.

3. The bearing holding device according to claim 1, wherein a support portion that restricts movement of the sliding bearing to the one side is provided between the opposing surface and the end surface of the sliding bearing in the axial direction.

4. The bearing holding device according to claim 3, wherein the support portion is formed of an elastic member elastically deformable in the axial direction.

5. The bearing holding device according to claim 1, wherein the sliding bearing is an oil-impregnated bearing containing lubricant.

6. The bearing holding device according to claim 5, wherein a viscosity of the lubricant at 40° C. is 8 mm²/s or more and 20 mm²/s or less.

7. The bearing holding device according to claim 1, wherein
the sliding bearing has a through-hole into which the shaft is inserted, and
the through-hole has a tapered shape in which an inner diameter thereof decreases toward a center in the axial direction.

8. The bearing holding device according to claim 1, wherein a damping member having higher damping force than that of the holding portion is interposed between the claw portion and the sliding bearing.

9. The bearing holding device according to claim 1, wherein
a tubular portion surrounding the holding portion from an outside of the holding portion in the radial direction is provided on the outside, and
a damping member having higher damping force than that of the holding portion is interposed between the claw portion and the tubular portion.

10. A motor comprising:
a rotor and a stator built in a housing; and
a shaft rotatable integrally with the rotor, wherein
the bearing holding device according to claim 1 holds a sliding bearing fixed to the housing and rotatably supporting the shaft.
